(19) United States
(12) Patent Application Publication
(10) Pub. No.: US 2026/0080623 A1
(43) Pub. Date: Mar. 19, 2026

(54) SYSTEMS AND METHODS FOR HUMAN-OBJECT INTERACTION TRACKING

(71) Applicant: Honda Motor Co., Ltd., Tokyo (JP)

(72) Inventors: Enna SACHDEVA, Santa Clara, CA (US); Pin-Hao Huang, San Jose, CA (US); Kwonjoon Lee, San Jose, CA (US); Behzad Dariush, San Ramon, CA (US); Zekun Li, Providence, RI (US)

(21) Appl. No.: 19/065,346

(22) Filed: Feb. 27, 2025

Related U.S. Application Data
(60) Provisional application No. 63/695,247, filed on Sep. 16, 2024.

(51) Int. Cl. G06T 17/20; G06T 7/11; G06T 7/20; G06T 7/73

(52) U.S. Cl. CPC G06T 17/20; G06T 7/11; G06T 7/20; G06T 7/73; G06T 2207/20084; G06T 2207/30196

(57) ABSTRACT

A system and method for improving the accuracy of human-object interaction tracking includes a unified tracking system. The tracking system uses an autoregressive architecture to process incoming image data and motion data in real-time and generates mesh states and a pose distribution. Post sampling leverages motion data to select optimal samples from the pose distribution.

### CROSS-REFERENCE TO RELATED APPLICATIONS

This application claims the benefit of Provisional Patent Application No. 63/695,247 filed Sep. 16, 2024, and titled “Human-Object Interaction Tracking with Pose Uncertainty,” which is incorporated by reference herein in its entirety.

### BACKGROUND

Advances in machine learning have empowered human and object interaction tracking. Such innovations have applications in intelligent vehicles, digital health, and emotion recognition. User behavior prediction is critical for safe and smooth human-machine interaction, especially for interactions in mobility. Popular applications include automated vehicles (AV).

Human-Object interaction (HOI) tracking may suffer from issues related to the amount and type of sensory information available. In many settings, there may not be sufficient sensors, including both cameras and motion sensors, to track movement and interactions with high precision.

There is a need in the art for a system and method that addresses the shortcomings discussed above.

### SUMMARY

Embodiments provide herein disclose methods and systems for improving human-object interaction (HOI) tracking, especially in contexts where only one camera (monocular video) may be available. The systems and methods utilize a unified human-object interaction tracking system that has an autoregressive architecture and utilizes post sampling to produce predicted pose information including non-determinate outputs.

In some aspects, the techniques described herein relate to a system for improving the accuracy of modeling human-object interaction tracking, the system including: a processor configured to: receive, from a camera, first data corresponding to a first image and a second image of a human and an object; process the first data to generate a mesh for the human and the object; generate a pose distribution using the mesh; obtain pose data by sampling the pose distribution ; receive second data corresponding to the second image and a third image of the human and the object; and process the second data and the sampled pose data to generate an updated mesh for the human and the object.

In some aspects, the techniques described herein relate to a method of improving the accuracy of modeling human-object interaction tracking, including: receiving, at a tracking system including at least one neural network, first data corresponding to a first image and a second image of a human and an object; processing, by the tracking system, the first data to generate a mesh for the human and the object; generating, by the tracking system, a pose distribution using the mesh; sampling, by the tracking system, pose data from the pose distribution; receiving, at the tracking system, second data corresponding to the second image and a third image of the human and the object; and processing, by the tracking system, the second data and the sampled pose data to generate an updated mesh for the human and the object.

In some aspects, the techniques described herein relate to a method of improving the accuracy of modeling human-object interaction tracking, including: receiving, from a camera, a video feed of a human interacting with an object, the video feed including a first image associated with a first time and a second image associated with a second time, the second time occurring after the first time; generating a first input dataset corresponding to the first image and generating a second input dataset corresponding to the second image; feeding the first input dataset to a first neural network and generating a first feature map associated with the first image; obtaining, by sampling a human and object pose distribution, a first initial mesh for the human and the object corresponding to the first time; feeding the second input dataset to a second neural network and generating a second feature map associated with the first image and generating a second initial mesh for the human and the object corresponding to the second time; using the first feature map and the first initial mesh to generate a first feature vector set for object vertices and human vertices corresponding to the first time; using the second feature map and the second initial mesh to generate a second feature vector set for object vertices and human vertices corresponding to the second time; processing, using a third neural network, the first feature map and the second feature map to create a current mesh for the human and the object; and updating, with the current mesh, the human and object pose distribution.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic view of an exemplary architecture for a human-object interaction tracking (HOI) system, according to an embodiment.

FIG. 2 shows a schematic view of an architecture in which HOI image data and motion data may be integrated by way of a pose distribution model, according to an embodiment.

FIG. 3 is a schematic view of an exemplary process for generating accurate pose distribution data that may be utilized by one or more systems.

FIG. 4 depicts the autoregressive structure of the architecture of the HOI tracking system, including three frames for a human and object mesh corresponding to three different times, according to an embodiment.

FIG. 5 is a schematic view of an architecture for a unified HOI tracking system that may include one or more neural networks, according to an embodiment.

FIG. 6 is a schematic view of an image encoding and pose initialization portion of the architecture of FIG. 5, according to an embodiment.

FIG. 7 is a schematic view of a feature projection portion of the architecture of FIG. 5, according to an embodiment.

FIG. 8 is a schematic view of a feature fusion and mesh reconstruction portion of the architecture of FIG. 5, according to an embodiment.

FIG. 9 is a schematic view of a portion of the architecture of FIG. 5 for mapping a mesh state to a pose distribution, according to an embodiment.

FIG. 10 is a schematic view of a post sampling portion of the architecture of FIG. 5, according to an embodiment.

### DETAILED DESCRIPTION

Embodiments provided herein disclose systems and methods for improving human-object interaction (HOI) tracking, especially in contexts where only one camera (monocular video) may be available. In such contexts where only 2D images from a single vantage point (camera) of a scene is captured, modeling human-object interactions may suffer from at least two drawbacks: (1) occlusion of the human and/or object within the image and (2) differences in scale between the human and object. The exemplary embodiments provide a system and method that may improve precision of HOI tracking with uncertainty in a variety of different contexts as long as at least one camera is available and as long as there is some additional form of motion data from one or more motion sensors, such as data from an inertial measurement unit (IMU) associated with the human and/or object. In particular, the exemplary embodiments utilize an autoregressive architecture along with post sampling to generate probabilistic outputs (a pose distribution model) that may be used to reconcile HOI image data with IMU or other motion-based sensor data to achieve improved accuracy in reconstructing human and object poses. Moreover, by using an autoregressive architecture with post sampling, the exemplary system may provide results in real time that are sufficiently robust to occlusion and problems with scaling. By contrast, other systems for HOI tracking may require processing a whole video, which is not amenable to real-time applications, and which produce more limited determinate outputs.

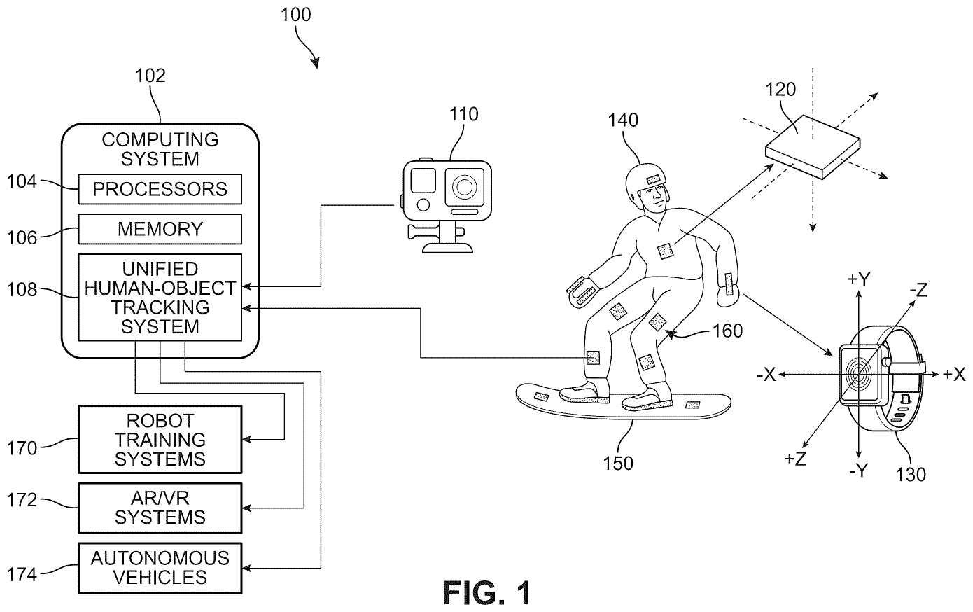

FIG. 1 is a schematic view of an exemplary architecture for an HOI tracking system 100, according to an embodiment. HOI tracking system 100 may include one or more computing systems 102. Computing systems 102 may include processors 104 and memory 106. Memory 106 may store instructions that may be executed by processors 104.

In some embodiments, computing system 102 includes a unified HOI tracking system 108 stored in memory 106. This module may include any suitable algorithms for executing the processes described below and shown in the Figures. In some embodiments, system 108 may include one or more neural networks. Exemplary networks that may be used include various neural networks. Exemplary neural networks that can be utilized in various implementations include multilayer perceptrons (MLPs), which are a class of feedforward neural networks composed of fully connected layers. Embodiments may also use convolutional neural networks (CNNs) that are designed for processing grid-like data structures such as images and excel in feature extraction for applications like object detection and image classification. Embodiments may also use recurrent neural networks (RNNs) and their variants, including long short-term memory (LSTM) networks, which are tailored for sequential data analysis, making them ideal for natural language processing, time-series forecasting, and speech recognition. Embodiments may also use transformer-based architectures, known for their self-attention mechanisms, which provide superior performance in handling large-scale text and sequence data, as seen in modern language models. Embodiments may also use generative adversarial networks (GANs) that combine a generator and a discriminator in a competitive setup to produce high-quality synthetic data, including images, videos, and other types of creative content. Additionally, graph neural networks (GNNs) may be used, which specialize in processing data structured as graphs, enabling significant advancements in fields like molecular property prediction, social network analysis, and recommendation systems.

Computing system 102 may receive information from one or more sensors. In some embodiments, computing system 102 may receive information, including image data, from a camera 110. The embodiments may utilize various types of cameras for capturing images, including still cameras, video cameras, and multi-functional devices capable of image acquisition. Exemplary video cameras that can be utilized include portable action cameras, which are compact, rugged, and designed for capturing high-quality video in dynamic and outdoor environments. Smartphone cameras with video capabilities provide portability and convenience, often equipped with advanced computational photography features, may also be used. High-speed cameras, capable of recording at hundreds or thousands of frames per second, may also be used.

Cameras utilized in the embodiments may be equipped with a variety of sensors to meet different application needs. Complementary metal-oxide-semiconductor (CMOS) sensors are widely used due to their high speed, low power consumption, and ability to capture high-resolution images and videos. Other embodiments may use camera sensors including charge-coupled device (CCD) sensors, known for their low noise and high image quality, and backside-illuminated (BSI) CMOS sensors that enhance light sensitivity, making them ideal for low-light conditions.

Computing system 102 may receive information from one or more motion sensors. Exemplary motion sensors include inertial measurement units (IMUs), such as IMU 120. While the embodiments depict the use of IMUs, other suitable motion sensors may be used including optical motion sensors, ultrasonic sensors, magnetic motion sensors, capacitive motion sensors, gyroscopes, or other suitable sensors.

IMUs, or other motion sensors, may be embedded into wearable devices, such as a smartwatch 130, and/or may be integrated into clothing, straps, cases, harnesses, or other items worn by a human (or user). IMUs or other suitable sensors may also be attached to objects. As an example, a human 140 is shown in FIG. 1 standing on object 150, which is depicted as a snowboard. Both human 140 and object 150 may have multiple motion sensors 160 attached to them. The motion data for both human 140 and object 150 may be sent from the motion sensors 160 to computing system 102.

Image data from camera 110 and motion data from one or more of motion sensors 160 may be received at computing systems 102 and further processed using tracking system 108. In use, both forms of data are used to model and track the movement of human 140 and object 150, including generating likely poses for both human 140 and object 150 at different points in time.

The generated data, including poses, may be fed to other systems. For example, data may be provided to robotics training systems 170. Robotic systems may use HOI data to interpret human behaviors and intentions, allowing the robotic systems to perform a wide range of tasks. The data may also be used for AR/VR systems 172, allowing these systems to better simulate human/object interactions and improve the user experience. The data may also be used in autonomous vehicles 174, for example, to help an autonomous vehicle interpret the actions/behaviors of a pedestrian outside of the vehicle.

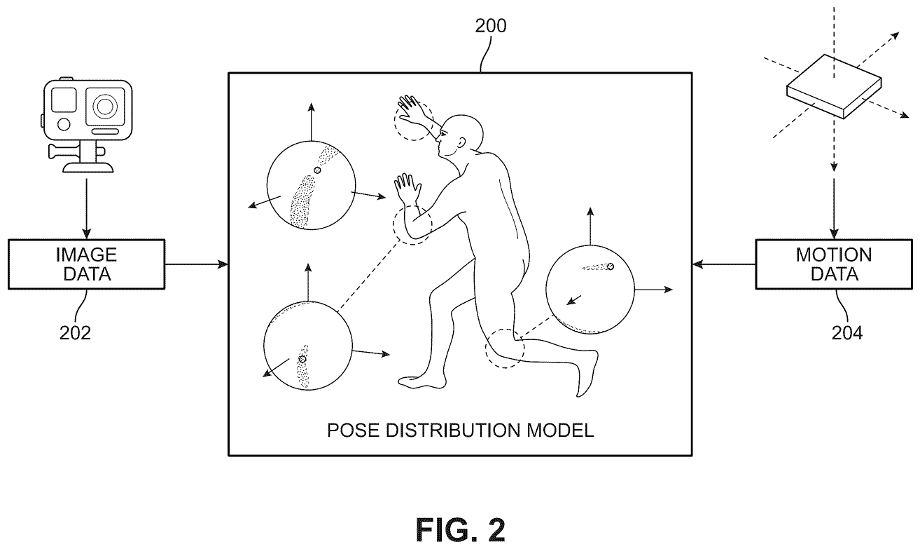

Integrating HOI data from images with motion data captured by sensors such as IMUs may be challenging. In particular, the pose data generated by an HOI modeling system may not be calibrated with data generated by IMUs or related motion sensors. A feature of the exemplary systems and methods is the use of a pose distribution model to seamlessly integrate HOI image data with motion sensor data without the additional computational cost of training the HOI modeling system with motion sensor data a priori. That is, using the exemplary systems and methods, the HOI image data and motion sensor data that are collected in real time may be unified to create highly accurate pose data for use by other systems. This unified framework for integrating data from disparate sources that may not be previously calibrated or trained, may be accomplished by using a pose distribution model. For example, FIG. 2 shows a schematic view of an architecture in which image data 202 and motion data 204 may be integrated by way of a pose distribution model 200. The pose distribution model 200 provides a distribution of poses for humans and/or objects at each instance in time rather than using a fixed (determinate) pose at each instance. In one implementation, as discussed in further detail below, image data is used to generate a pose distribution at each time, and the pose distribution may be sampled in a way that leverages real-time motion data to improve accuracy and reduce error accumulation.

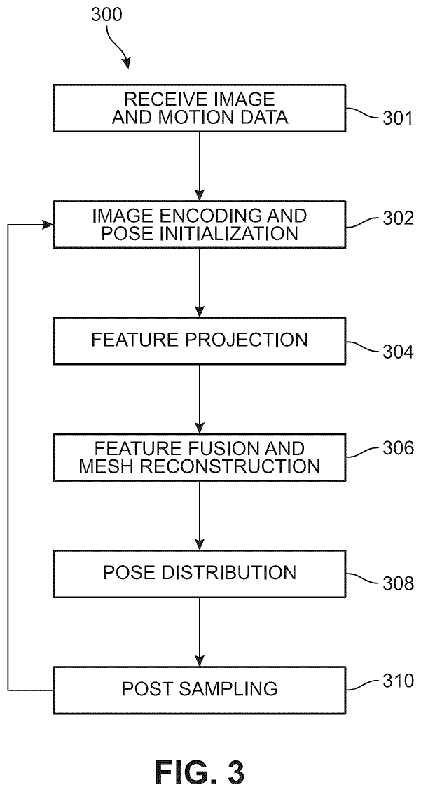

FIG. 3 is a schematic view of an exemplary process 300 for generating accurate pose distribution data that may be utilized by one or more systems. In some cases, one or more of the following operations may be performed by a component of an HOI tracking system, such as HOI tracking system 100 of FIG. 1. In some cases, one or more operations of process 300 may be performed by unified HOI tracking system 108.

In operation 301, image and motion data may be received by HOI tracking system 108. In some cases, image data may be received from a camera, such as camera 110 of FIG. 1. Image data may be provided in any suitable format, including compressed and uncompressed formats, and may comprise pixel data including RGB intensity in different color channels.

In some cases, image data may include one or more images. In some cases, image data may include a video feed comprised of a sequence of images. Motion data may comprise, for example, timestamp data, 3-D accelerometer data, 3-D gyroscope data, and 3-D magnetometer data. Once received, motion data may be processed to generate location and/or trajectory (or orientation) information corresponding to the locations/orientations of the sensors attached to a human and/or object. In some cases, this data may be converted to point-cloud data.

In operation 302, HOI tracking system 108 may perform image encoding and pose initialization. In some cases, image encoding and pose initialization are performed using only the image data, or data derived from the images. In particular, in some cases, no motion sensor data may be used to generate the initial poses. In some cases, initial pose data may be determined using a sampling process that samples from a pose distribution in a way that is informed by motion data.

In operation 304, HOI tracking system 108 may perform feature projection. In particular, 2D image features determined in operation 304 may be converted into 3D features.

In operation 306, HOI tracking system 108 may perform feature fusion and mesh reconstruction. This may include fusing the human and object features, including areas of contact, and reconstructing the human and object meshes (which are 3D models of the human and object) from the fused features.

In operation 308, HOI tracking system 108 may determine a pose distribution. In some cases, the pose distribution may be determined analytically from the reconstructed meshes.

In operation 310, HOI tracking system 108 may perform post sampling. In particular, using information from the motion data received in operation 301, HOI tracking system 108 may sample poses from the pose distribution and use the sampled data for performing the pose initialization in operation 302.

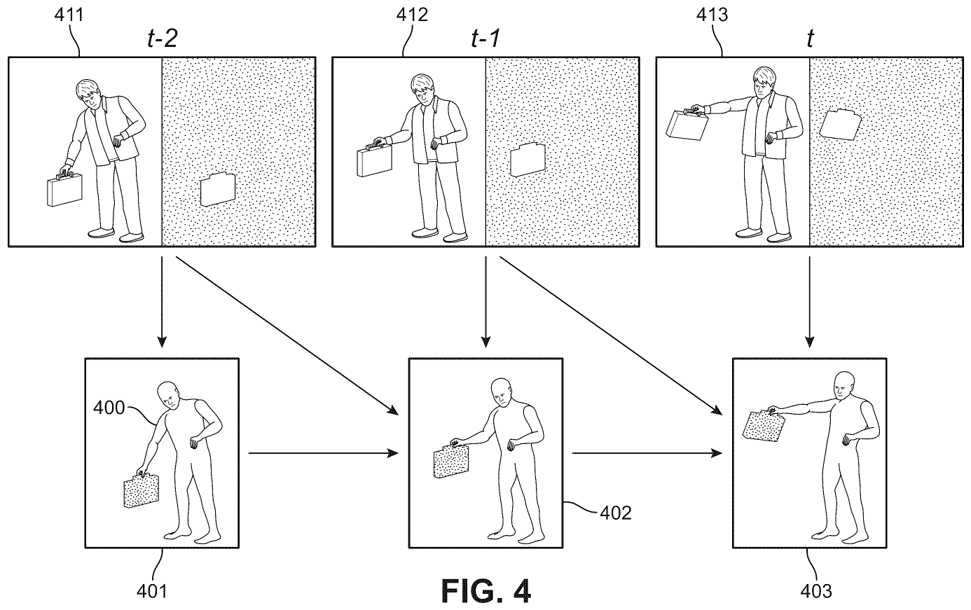

A feature of the exemplary systems and methods is the use of autoregressive techniques. For purposes of illustration, FIG. 4 depicts three frames (frame 401, frame 402, and frame 403) for a human and object mesh 400 corresponding to times t-2, t-1, and t. In each frame, human and object mesh 400 has a slightly different pose to capture the changes in pose of the human and object from the underlying images captured using a camera. Moreover, the different poses for human and object mesh 400 are determined according to input data comprised of images and segmentation masks. Specifically, first input data 411, second input data 412 and third input data 413. For clarity, only the segmentation mask for the object is shown in FIG. 4, however the input data may also include segmentation masks for the human as well.

As shown in FIG. 4, human and object pose data is predicted using not only the image (and segmentation data) for the current time (e.g., time “t”), but also using image (and segmentation data) from the previous time (e.g., time “t-1”). For example, the pose of human and object mesh 400 in frame 402 is determined using input image data 412 associated with time t-1 as well as input image data 411 associated with time t-2. Using this autoregressive architecture, predictions can be made on a frame-by-frame (or image-by-image) basis, rather than analyzing an entire video or other large set of frames to derive information. Moreover, the autoregressive architecture utilizes information from previous frames to inform predictions for current frames, rather than using only information extracted from the current frame to make predictions. This configuration allows for real-time predictions so that the data can be integrated with motion sensor data and used in real time by one or more downstream applications. For example, using this autoregressive process, highly accurate pose data may be captured and sent to a robotic system, for example, during a session in which a robot is trained by a user, or else attempts to mimic the user in real time.

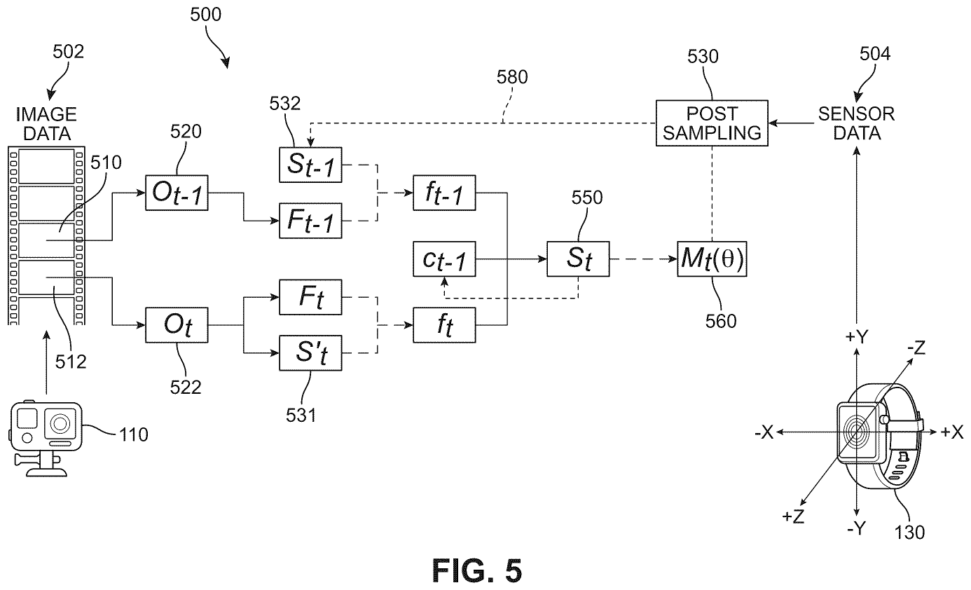

FIG. 5 is a schematic view of an architecture 500 for unified HOI tracking system 108 (or simply “tracking system 108”) that may be used to perform one or more of the operations discussed above and shown, for example, in FIG. 3. In one embodiment, architecture 500 may be comprised of various portions that perform different processes and connect different nodes of the architecture. Architecture 500 comprises multiple linked processes, some of which may be accomplished using neural networks (and indicated with solid lines) and some which are determined by other processes (indicated with dotted lines).

Architecture 500 may make use of meshes. As used herein, a 3D mesh, or simply “mesh”, may refer to any suitable collection of geometric data used to encode or represent the surface of a human and/or 3D object. In some cases, mesh data may include vertices, faces, edges, vertex normal vectors, texture coordinates, and/or color information. An exemplary mesh using the Skinned Multi-Person Linear (SMPL) model may comprise data representing vertices, faces, skeletal features and joints, and the normal vectors at each vertex.

Architecture 500 makes use of 2D and 3D features, which may be extracted from image data, mesh data, or other suitable data. For a human, these 2D and 3D features may comprise data such as the locations of joints, limb orientation, locations of key body parts such as hands and feet, textural information, trajectory information, or other suitable representative data from which a full 3D model or mesh of the human can be inferred. For an object, these 2D and 3D features may include object categories, position and orientation information, object state information, as well as other suitable representative data from which a full 3D model or mesh of the object can be inferred. 2D and 3D features may be provided as vectors, and may comprise the inputs to, or outputs of, a given neural network or other process associated with architecture 500.

Inputs to architecture 500 include image data 502 from camera 110 and sensor data 504 from one or more motion sensors (such as from sensors in smartwatch 130). Image data 502 is fed into the initial layers or inputs of architecture 500. By contrast, sensor data 504 is used by the post sampling processes 530. In some cases, image data 502 and/or sensor data 504 may be vectorized for use with suitable networks or other algorithms.

Outputs of architecture 500 include the predicted mesh state 550 of the human and object at the current time t, which is indicated as state Sₜ, and the pose distribution 560, indicated as Mₜ(θ). The mesh state 550 and/or pose distribution 560 may provide pose information for use by downstream systems, such as robotic systems, autonomous vehicle systems, or other suitable systems requiring HOI information.

The autoregressive structure of architecture 500 may be clearly seen in the simultaneous processing of sequential data. Specifically, image data 502 is provided as sequential inputs, such that information from a first image 510 at a first time t-1 is provided at a first input 520. Likewise, information from a second image 512 at a second time t is provided at a second input 522. That is, architecture 500 utilizes information from two subsequent images according to the autoregressive design, allowing for better predictions of pose information by leveraging information not only from the current frame (whose pose is being predicted) but also using information from the previous frame (which contains information that can be used to infer future poses).

The exemplary systems and methods use post sampling processes to incorporate sensor data. That is, sensor data 504 is not fed directly into the inputs of architecture 500 like the image data 502, but rather is incorporated as part of post sampling processes 530. Information from post sampling processes 530 is then passed back to earlier layers of architecture 500, as discussed in further detail below. By using real-time motion sensor data to inform post sampling processes 530, the exemplary architecture 500 incorporates a feedback loop 580 that may help constrain errors generated during earlier pose estimation stages of architecture 500 and thereby improve accuracy of the final predictive states including mesh state 550 and pose distribution 560.

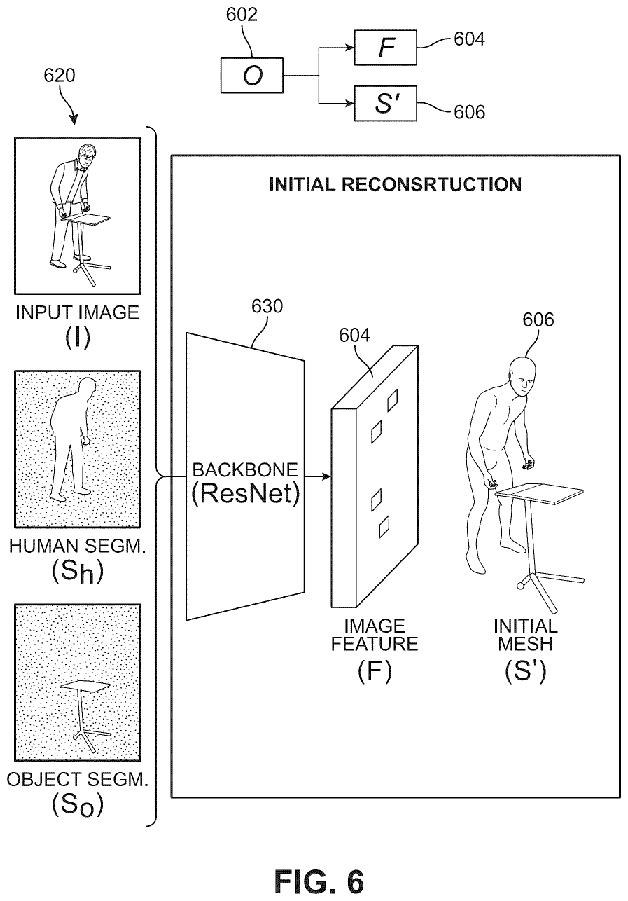

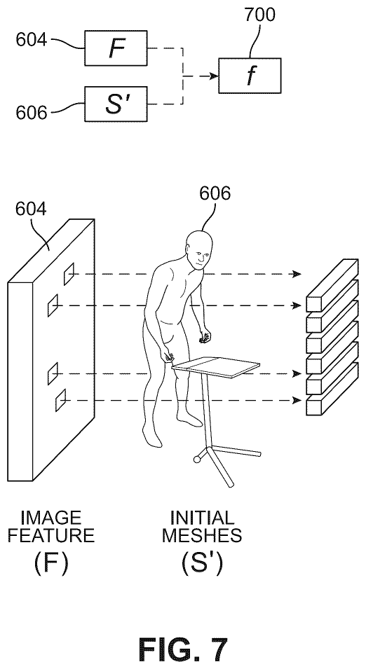

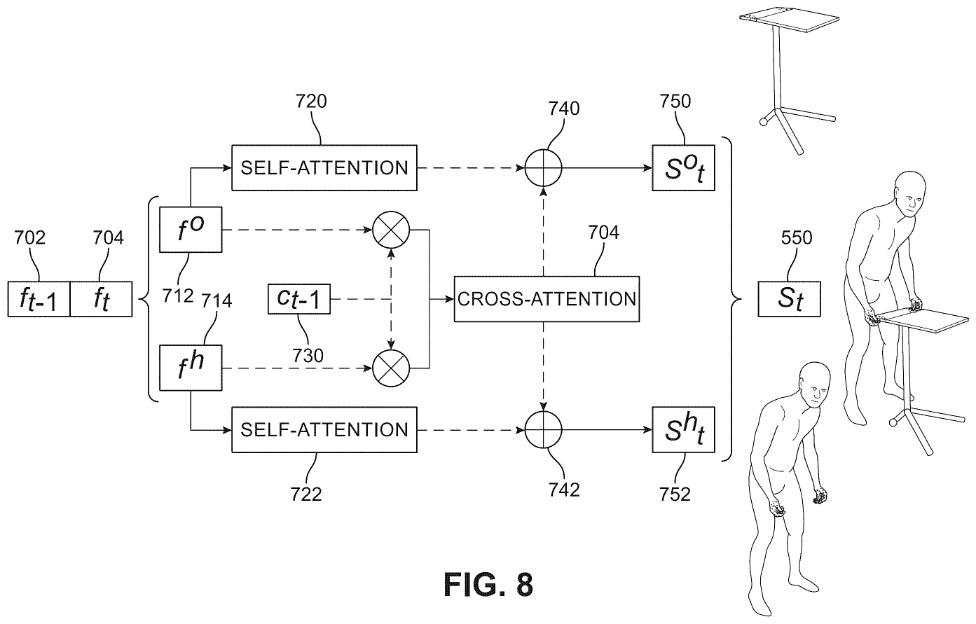

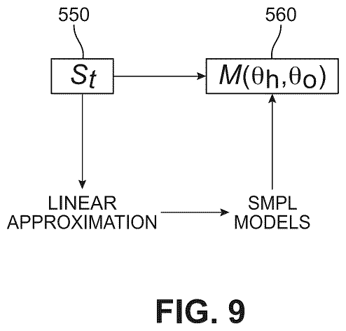

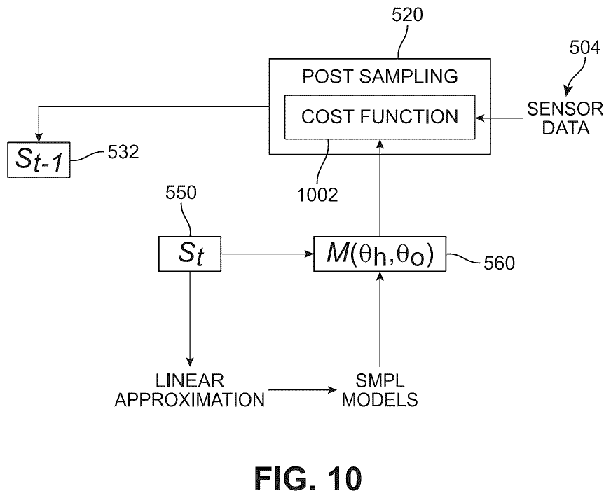

FIGS. 6 through 10 show schematic views of processes associated with different portions, or stages, of architecture 500. These generally correspond to stages of image encoding and pose initialization (FIG. 6), feature projection (FIG. 7), feature fusion and mesh reconstruction (FIG. 8), pose distribution approximation (FIG. 9), and post sampling (FIG. 10).

Referring now to FIG. 6, image encoding and pose initialization may be handled by early portions (or structures) of architecture 500. Broadly, observations from images are encoded into a set of observation nodes 602 (“O”), and suitable neural networks are used to generate both a 2D feature map 604 (“F”) and an initial mesh 606 for the human and object (box “S′”).

Image encoding may include providing RGB image data as well as producing segmentation data for the human and the object within the image. Any suitable algorithms for encoding image data and generating segmentation (or mask) data may be used. In some cases, encoded image data may be vectorized to facilitate processing by a neural network or other suitable process.

2D feature extraction and mesh estimation may be accomplished using any suitable algorithms or neural network architecture. In some embodiments, 2D feature extraction and mesh estimation may be accomplished using a convolutional neural network (CNN) and/or a multi-layer perceptron (MLP). In some cases, the CNN may be used to extract spatial or structural features from the image, while the MLP may be used to map these features to vertices or other mesh components.

As shown in FIG. 6, the processes associated with this portion of architecture 500 may include generating image and segmentation data 620. This data may then be processed using a backbone neural architecture 630 (such as ResNet) to generate image features. The image features of feature map 604 may then be used to predict parameters of the initial mesh 606 (or, in some cases, separate meshes for the human and object).

For purposes of clarity, FIG. 6 depicts one branch of the image encoding and pose initialization process, corresponding to processing one image. However, as seen in FIG. 5, architecture 500 uses parallel branches to encode two images simultaneously, corresponding to a set of features for each of the two images as well as the initial meshes corresponding to each of the two images. One distinction between the two branches, as clearly shown in FIG. 5, is that for the most recent frame corresponding to time t, the initial mesh 531 is estimated using a neural network, while the initial mesh 532 for the previous frame at time t-1 is obtained by sampling the pose distribution 560.

Referring next to FIG. 7, once the 2D feature map 604 and initial mesh 606 have been determined, the next step may be to determine the feature vector set 700 of object vertices and human vertices (“f”). In some cases, the transformation of information in 2D feature map 604 and initial mesh 606 to the feature vector set 700 includes using a camera projection equation to query the feature for each of the vertices in the initial mesh 606. In some cases, during training, initial mesh 606 may be obtained from a dataset, while during inference, initial mesh 606 may be obtained from previous iteration output. Of course, it may be appreciated that architecture 500 performs two branches of this same process in order to determine a first feature vector set for the image corresponding to time t-1 and a second feature vector set for the image corresponding to time t.

Referring next to FIG. 8, a portion of architecture 500 may be used to perform feature fusion and mesh reconstruction. This may be accomplished by leveraging self-attention layers and cross-attention layers.

This process may proceed by first concatenating the feature vector sets corresponding to the image observations at time t and time t-1. Specifically, feature set 702 (fₜ₋₁) and feature set 704 (fₜ) are concatenated and used to generate an object feature set 712 (f^{O}) and a human feature set 714 (f^{h}). These feature sets are fed into corresponding self-attention layers (first self-attention layer 720 and second self-attention layer 722) to refine the vertices of each feature set. At the same time, a contact mask 730 (cₜ₋₁) is applied to these two feature sets and then fed through a cross-attention layer 724.

Outputs from the self-attention layers and cross-attention layer are fused and fed into corresponding networks (a first neural network 740 and a second neural network 742) to generate object vertices locations 750 (S^{O}ₜ) and human vertices locations 752 (S^{h}ₜ). These are then used to create a reconstructed mesh, which is mesh state 550.

Referring now to FIG. 9, mesh state 550 may be used to determine pose distribution 560 directly. In some cases, this may be done analytically using a suitable linear approximation. In particular, from the mesh state 550 and a suitable linear approximation, parameters (θₕ) of the Skinned Multi-Person Linear model (SMPL) may be derived from the mesh state 550 and the corresponding pose distribution 560 may be derived.

Referring to FIG. 10, post sampling may be accomplished by sampling the pose distribution 560 while accounting for additional information in the form of sensor data. Specifically, post sampling processes 530 may incorporate a cost function 1002 that is associated with the alignment of the mesh state and information derived from motion sensor information. In some cases, the cost function includes motion sensor data as inputs and the process of finding a suitable sampling datapoint comprises minimizing the cost function as it ranges over values of sampled mesh states. By minimizing this cost function, the process may help select poses that are in sufficient agreement with what may be inferred about the pose from motion sensor data. That is, the motion sensor data is used to constrain predictions of pose information as that information is fed back into earlier stages of the network, thereby helping to reduce errors that otherwise might accumulate without such external constraints/information.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example. Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage unit in a well-known manner. Removable storage unit, represents a floppy disk, magnetic tape, optical disk, etc., which is read by and written to removable storage drive. As will be appreciated, the removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. A system for improving the accuracy of modeling human-object interaction tracking, the system comprising:
a processor configured to:
receive, from a camera, first data corresponding to a first image and a second image of a human and an object;
process the first data to generate a mesh for the human and the object;
generate a pose distribution using the mesh;
obtain pose data by sampling the pose distribution ;
receive second data corresponding to the second image and a third image of the human and the object; and
process the second data and the sampled pose data to generate an updated mesh for the human and the object.

2. The system according to claim 1, wherein the processor is further configured to sample the pose distribution by:
receiving motion data for the human and the object from one or more motion sensors; and
optimizing the sampling using the motion data.

3. The system according to claim 1, wherein the first data includes RGB data for the first image and for the second image, and wherein the first data includes human and object segmentation data for the first image and for the second image.

4. The system according to claim 1, wherein the processor is further configured to process the first data by using at least one neural network.

5. The system according to claim 4, wherein the at least one neural network includes a self-attention layer.

6. The system according to claim 4, wherein the at least one neural network includes a cross attention layer.

7. The system according to claim 1, wherein the processor is further configured to process the first data further by:
generating a first feature vector set for object vertices and a second feature vector set for human vertices; and
applying a contact mask to the first feature vector set and to the second feature vector set.

8. A method of improving the accuracy of modeling human-object interaction tracking, comprising:
receiving, at a tracking system including at least one neural network, first data corresponding to a first image and a second image of a human and an object;
processing, by the tracking system, the first data to generate a mesh for the human and the object;
generating, by the tracking system, a pose distribution using the mesh;
sampling, by the tracking system, pose data from the pose distribution;
receiving, at the tracking system, second data corresponding to the second image and a third image of the human and the object; and
processing, by the tracking system, the second data and the sampled pose data to generate an updated mesh for the human and the object.

9. The method according to claim 8, wherein sampling the pose distribution further includes:
receiving motion data for the human and the object from one or more motion sensors; and
optimizing the sampling using the motion data.

10. The method according to claim 8, wherein the first data includes RGB data for the first image and for the second image, and wherein the first data includes human and object segmentation data for the first image and for the second image.

11. The method according to claim 8, wherein processing the first data includes using at least one neural network.

12. The method according to claim 11, wherein the at least one neural network includes a self-attention layer.

13. The method according to claim 11, wherein the at least one neural network includes a cross attention layer.

14. The method according to claim 8, wherein processing the first data further includes:
generating a first feature vector set for object vertices and a second feature vector set for human vertices; and
applying a contact mask to the first feature vector set and to the second feature vector set.

15. A method of improving the accuracy of modeling human-object interaction tracking, comprising:
receiving, from a camera, a video feed of a human interacting with an object, the video feed including a first image associated with a first time and a second image associated with a second time, the second time occurring after the first time;
generating a first input dataset corresponding to the first image and generating a second input dataset corresponding to the second image;
feeding the first input dataset to a first neural network and generating a first feature map associated with the first image;
obtaining, by sampling a human and object pose distribution, a first initial mesh for the human and the object corresponding to the first time;
feeding the second input dataset to a second neural network and generating a second feature map associated with the first image and generating a second initial mesh for the human and the object corresponding to the second time;
using the first feature map and the first initial mesh to generate a first feature vector set for object vertices and human vertices corresponding to the first time;
using the second feature map and the second initial mesh to generate a second feature vector set for object vertices and human vertices corresponding to the second time;
processing, using a third neural network, the first feature map and the second feature map to create a current mesh for the human and the object; and
updating, with the current mesh, the human and object pose distribution.

16. The method according to claim 15, wherein the first neural network and the second neural network include a convolutional neural network.

17. The method according to claim 15, wherein the first neural network and the second neural network include a multilayer perceptron.

18. The method according to claim 15, wherein sampling the human and object pose distribution further includes receiving motion data and optimizing the sampling using the motion data.

19. The method according to claim 15, wherein the third neural network comprises a self-attention layer.

20. The method according to claim 15, wherein the third neural network comprises a cross-attention layer.
